(19) United States
(12) Patent Application Publication
(10) Pub. No.: US 2020/0198575 A1
(43) Pub. Date: Jun. 25, 2020

(54) Covert Vehicle Tracking and Immobilization System

(71) Applicant: Philip Maeda, Torrance, CA (US)

(72) Inventor: Philip Maeda, Torrance, CA (US)

(73) Assignee: Rydeen North America, Inc., Torrance, CA (US)

(21) Appl. No.: 16/229,187

(22) Filed: Dec. 21, 2018

(51) Int. Cl. B60R 25/042; B60R 25/33; B60R 25/30; B60R 1/12; G01S 19/13

(52) U.S. Cl. CPC B60R 25/042; B60R 25/33; B60R 2025/0415; B60R 1/12; G01S 19/13; B60R 25/30

(57) ABSTRACT

A vehicle immobilization system which includes electronic systems mounted in the vehicle rear-view housing. The vehicle becomes disabled, at predetermined conditions, when a signal from a remote source is transmitted to the vehicle.

### 1. FIELD OF THE INVENTION

The present invention relates to a vehicle tracking and immobilization system imbedded and hidden within a rear-view mirror housing. The mirror housing contains electronic systems for the tracking and immobilizing the vehicle at predetermined times.

The propose of this current embodiment would be to conceal systems that could be used to track and or disable a vehicle by authorized government or financial institutions when certain requirements are not adhered to. One of these situations would be subprime automotive financing to insure timely payments are made on the vehicle financing contract. Another would be if a court or legal order was not followed such as in the case of drunk driving when, a breathalyzer is installed or in the case of a court ordered curfew. These are the few examples of situations that could require this type of covert, device. The purpose of concealment within the rear-view mirror housing is that the users of the vehicles would not easily be able to locate and disable such a device and the position of the rear-view mirror offers an ideal position for OPS as well as Cellular communication with an unobstructed view of the sky. The mirror housing would contain a GPS system and a cellular communications device as well as other electronics that could be built in and offer more features for the driver of the vehicle. These extra systems can be included but not limited to, a screen for navigation or reverse parking aid, camera systems with recording functions and to display information that may be useful for the driver.

### 2. DESCRIPTION OF THE PRIOR ART

Financial institutions that deal is subprime automotive loans have often placed tracking and disabling systems in vehicle to insure contract payments are made on time and in accordance with the terms of the loan. Drivers that realize that these systems may have been installed within their vehicles often aggressively seek to find and disable these systems. With a basic understanding of the workings of these types of systems a general location of the installed system can easily be determined. Once found, they can be disables with minimal effort and negate the protection added by the lender. By simply finding the wiring to the system it can be disabled by disconnecting the power or even the antenna that is needed for the external communication.

This situation is also true in cases for court ordered devices that would only allow the use of the vehicle at specific times or under specific conditions. If these systems are easily found and disabled, they would have virtually no use and will not offer the protection that the courts have found necessary. The rear-view mirror offers a discrete and covert location for these types of systems that would more than likely be overlooked by a user seeking to locate and defeat these systems. This also allows ease of installation and could offer more built in benefits that could be sold or enhance the features and price of the vehicle. The placement of the tracking and disabling system within a common component of every vehicle would greatly reduce the user's ability to locate and disable such systems.

### SUMMARY OF THE INVENTION

The present invention provides a covert method of installing a tracking system that can locate the vehicle and disable systems that are required for the normal operation of the said vehicle. A cc ion rear-view mirror could be replaced with a like mirror that would contain a GPS, (Global Positioning System). This system would be able to locate the vehicle either streaming the vehicles information provided by the GPS system over cellular networks or seek this information on demand on demand from an) computer or interact enabled devise. The GPS and location would be necessary to ensure that if the vehicle were to be disabled, it would not occur when the vehicle was in operation. The systems of the vehicle could only be disabled when the vehicle was stationary, and the ignition was in an OFF state. If the vehicle was in operation at the time of activation it could potentially cause, bodily injury or death to those in or around the vehicle at that time. If systems are disables while a vehicle is in motion, loss of braking, steering and general control of the vehicle would be affected. This could lead to major incidence, harming innocent drivers or people and would be a tremendous liability factor.

The system would be set up in such a manner that this could not occur regardless if such a disable WIT and was given. The GPS and vehicle ignition status would act as a safeguard and the system could only be activated when the vehicle vas at a complete stop and the ignition of the vehicle was in an OFF-state insuring that the Vehicle w not in operation and safely parked.

A cellular radio or modem would also be installed within the structure that could broadcast the state of the systems of the vehicle as well as the GPS data to a network that could be accesses and monitored by any intern/et connected system such as but, not limited to a computer or cellular phone. The radio or modem could also send or receive signals or commands that would determine if the vehicle is to be deactivated in a parked state not allowing it to be operated by the user. If nonpayment or compliance to any contractual policy was not adhered to, the financial or government agency could send a command to the unit. Once the disable signal was received by the system the unit would first insure a parked state based or several factors including Ignition, position and speed determined by the GPS systems. This signal would be stored by a CPU and would deactivate the chosen system when info from the vehicles systems and GPS insured the said vehicle was not in use. This can be done hours or days of monitoring the vehicle in an OFF or parked state. Once the system insures the Vehicle is stationary and has been activated a connection would open a circuit not allowing the vehicle to function. This can be a single system such as the starter of the vehicle or multiple systems that are all required for the vehicle to operate. This can include but are not limited to: The starter, The ignition system or the fuel delivery system of the vehicle. This can be determined by the institution or operator of the said systems. A ground output can also be enabled that can be connected to an external circuit or relay that can be placed outside of the mirror structure, and disable items in a more covert manner. By use of the grounded output the relay or circuit and be hidden in any area of the vehicle including structures inaccessible to the driver of the vehicle. The GPS position, will also aid in the recovery of the vehicle since the exact position of the vehicle would be known.

There are many advantages to using the rear-view mirror assemblies to house the electronic needed for the system to operate. The first is that every vehicle has a rear-view mirror mounted in the upper center of the windshield of the vehicle. It is away from areas that contain the wiring of the vehicle and would not be easily considered by a user looking to find and deactivate a device of this type.

### DESCRIPTION OF THE DRAWINGS

For a better understanding of the present invention as well as other objects and further feature thereof, reference is made to the following description which is to be, read in conjunction with the accompanying drawing therein;

FIG. 1 illustrates the mirror assembly constructed in accordance with the teachings of the present invention;

FIG. 2 separately shows the front cover of the assembly shown in FIG. 1.

FIG. 3 illustrates the reflective mirror element and back cover when separated;

FIG. 4 illustrates the monitor and internal plate when separated;

FIG. 5 is a view showing the printed circuit board and main board when separated;

FIG. 6 is a schematic diagram of the cellular radio with GPS; and

FIG. 7 is a block diagram the complete system of the present invention.

### DESCRIPTION OF THE INVENTION

The present invention pertains to a cellular based global positioning system and vehicle control system within the vehicle mirror assembly for multiple applications. More specifically, the present invention consists of a vehicle mirror assembly having a built in cellular transceiver equipped with a GPS and logic control system for the purpose of knowing the location of a vehicle and controlling certain aspects including the ignition to disable the vehicle if needed. The mirror assembly which integrates a number of electronic devices to disable the vehicle when it is not in operation upon receiving a remotely generated signal.

This arraignment provides a covert mounting location that has access to the cellular and GPS signals required. This rear-view mirror assembly is mounted in the typical position within he said vehicle high and centered on the windshield. This will allow an unobstructed view of the sky allowing for the best possible GPS antenna reception to the geostationary satellites that emits the signals GPS is based upon. It also allows a suitable covert location for the cellular transceiver to have optimum cellular reception.

An interior assembly consisting of a variable reflectance element is provided and suitable mounting locations for the other imbedded electronic components and wiring.

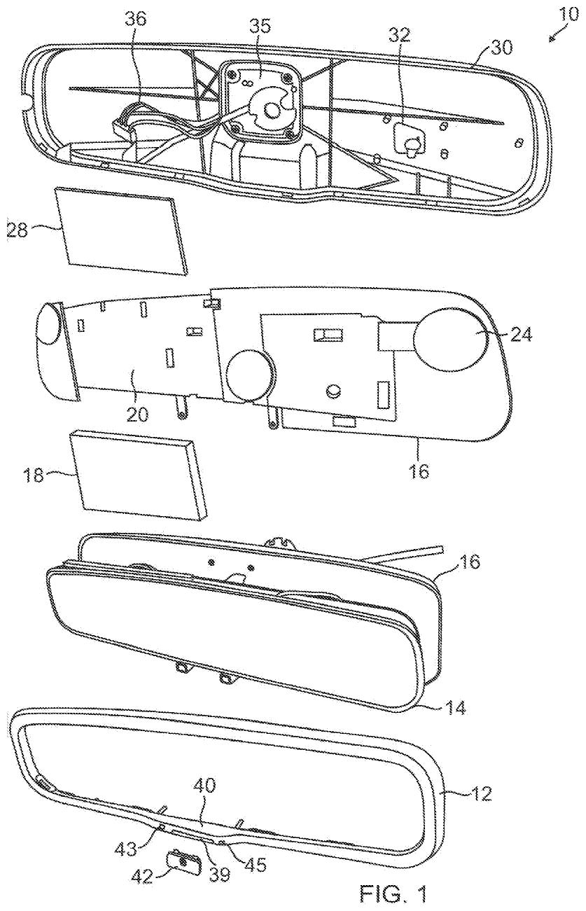

Referring specifically to FIG. 1, a view of the components which comprise the reflective mirror assembly 10 of the present invention is illustrated.

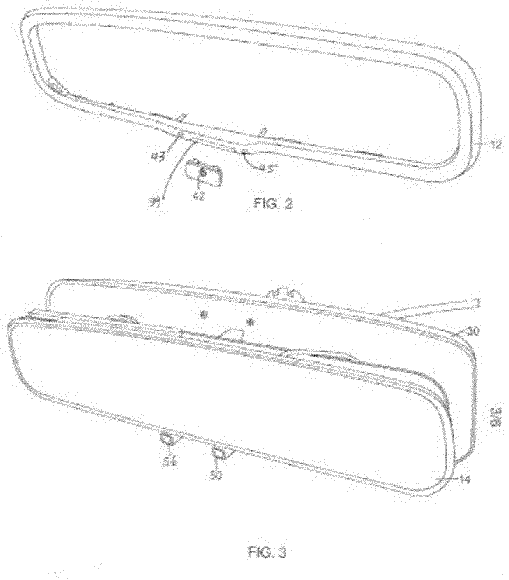

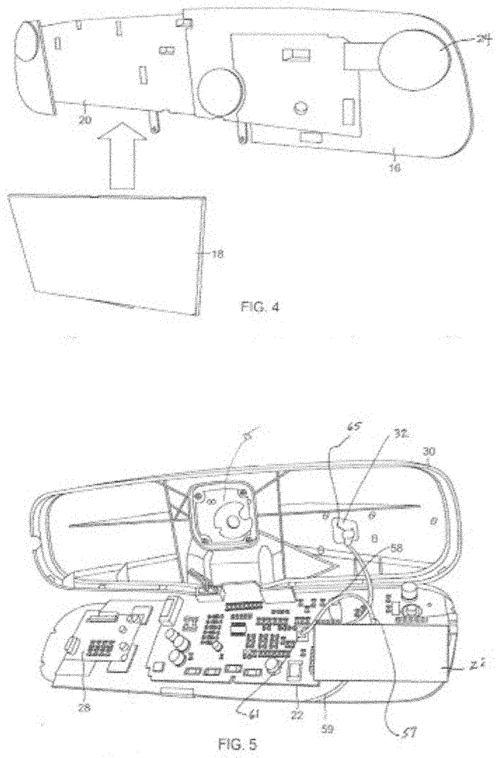

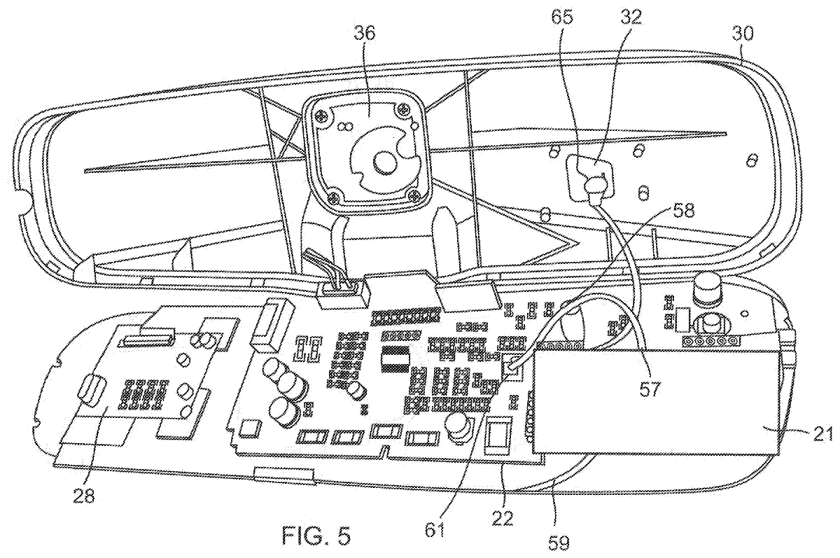

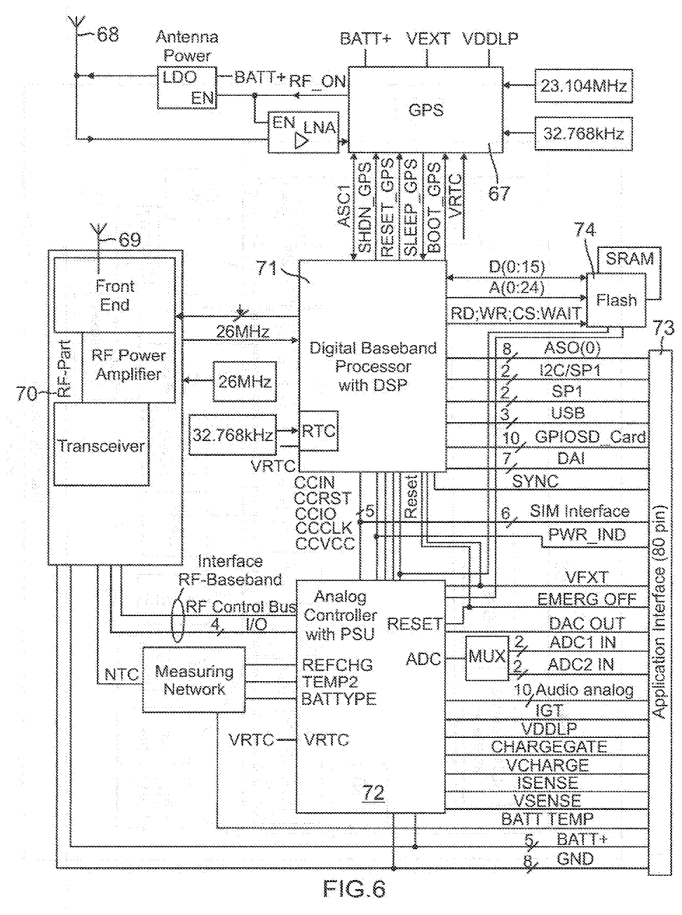

Specifically component 12 is the frame element (front cover), having an opening or recess, 40 to adjust the manual dimming of the mirror 42, component 14 is a reflective mirror which, as shown in FIG. 3, extends essentially over the entire length of mirror assembly 10, component 16 is an internal frame (shown in FIG. 4) designed to hold internal components 18 in recess 20 formed in component 16, component 28 is a printed circuit board (“PCB”) which contains a cellular transceiver PCB 28 being mounted to the rear surface of structure 16, an opening, or recess 24, for supporting circuit hoards and antenna assembly (not shown) and back cover 30 (FIGS. 5 and 6) an opening 35 through which power and data cables 36 extend and then are connected to the appropriate system components.

Since the reflective element covers the entire rear surface of the mirror, it can be used in a traditional manner to see the rear of the vehicle.

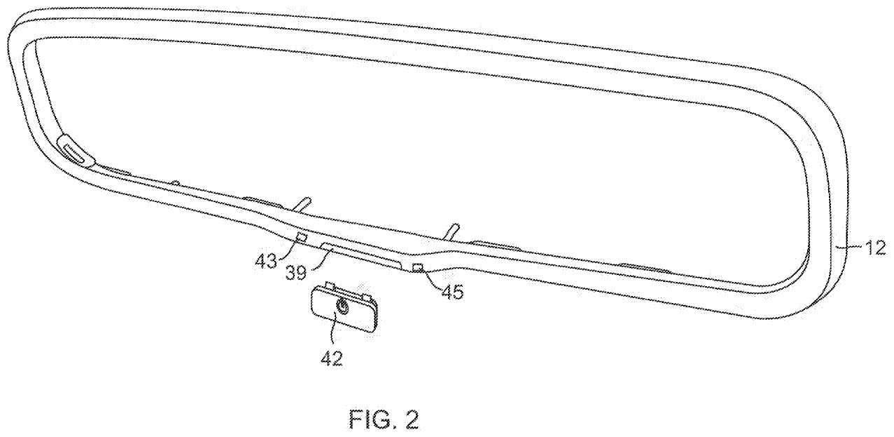

FIG. 2 illustrates in mote detail front cover 12 with optional recess 39 for receiving button 42 hole (opening) 43 for the manual dimming of the mirror.

FIG. 3 is a view of reflective mirror and back cover 30.

FIG. 4 illustrates the cellular transceiver and GPS radio 18 ready to be secured in recess 20 formed in internal frame structure 16,

FIG. 5 illustrates back cover 30 with window 32 for allowing the GPS antenna array 58 to receive radio signals and wires 36. Also shown is GPS receivers PCB 28, Cellular radio transceiver board 22 and connector 61, transparent connector 65 for cellular antenna 58, cable 57 for internal connections,

FIG. 6 is a schematic of a typical cellular and GPS transceiver using a Siemens XT-75 transceiver module used for this embodiment of the current invention. Other radio transceiver that are currently available and can also be used. The multiple I/O (input, outputs) available with this arrangement can be used for the physical cutoff of the vehicles internal components as needed as well as the ability to have multiple outputs to control relays that will disable vital engine functions in order to not allow the vehicle to start or run. These outputs will be connected through wire harness 36 in FIG. 1. The GPS Receiver 67 gathers satellite information from the cellular antenna 68 to determine the speed acrd location of the vehicle. The radio frequency cellular antenna 69 delivers cellular reception to the cellular radio transceiver 69 that can then communicate data and information to and from the vehicle and the user of the system. The analog controller 72 processes the information with the digital processor 71 to relay incoming data and vehicle data to the system that can be stored within the FLASH and SRAM memory 74 to be used as a buffer. The 110 or input output will be relayed through the main wire connector 73 of the system.

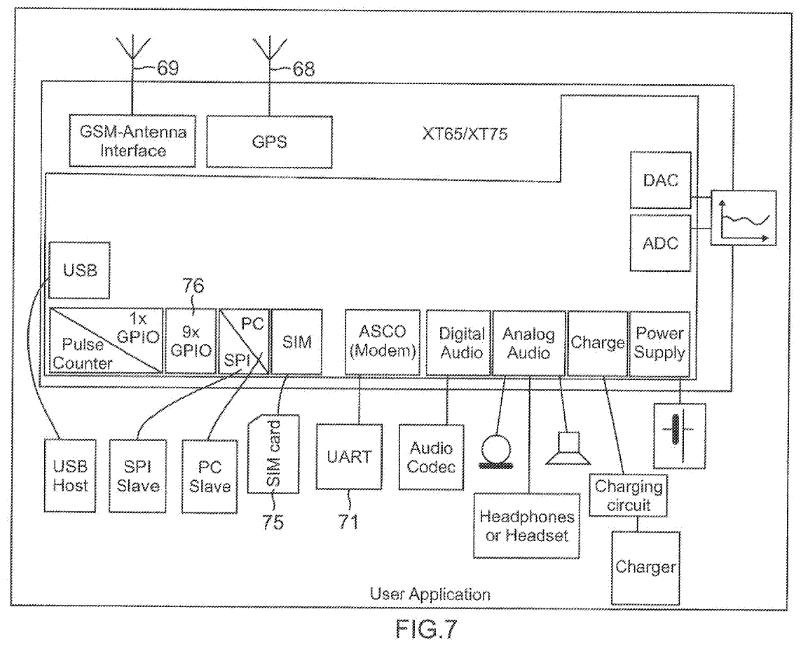

FIG. 7 is a block diagrams of the internal system that is configured in such a way as to disable or enable multiple circuits within the vehicle for optimum control of the needed functions. These functions varies depending on the intended use of the system based on the customer's needs. The GPS and Cellular antennas 68 and 69 will be connected to the radios for the reception and transmission of signals to and from the vehicle. The cellular SIM card 75 will be used by the device to connect to the cellular systems provider that will identify the unit in use. The GPIO 76 opens and closes circuits to perform the disabling of the vehicles systems as needed.

While the invention has been described with reference to its preferred embodiments it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

What is claimed is:

1. A modified rear-view mirror assembly containing a processor, global positioning system and cellular radio or modem to send and receive data; the position of the vehicle the CPU having being determine via the global positioning system comprising inputs and outputs that transmitted read analog data from the vehicle wherein said CPU is externally to effect the operation of the vehicle where said

2. A rear-view assembly as in claim 1 triggered to disable the ignition of said vehicle.

3. A rear-view assembly as in claim 1 where said processor is externally triggered to disable the starter of said vehicle.

4. A rear-view assembly as in claim 1 wherein said is externally triggered to disable the fuel system of said vehicle.

5. A rear-view assembly as in claim 1 wherein said is externally triggered to disable the multiple control items of said vehicle.

6. A rear-view assembly as in claim 1 that controls multiple normally closed relays that can disable the system to which they are connected.

7. A rear-view assembly as in claim 1 that disables said vehicle based on time, day and date.

8. A modified rear-view mirror assembly containing a processor, global positioning system and cellular radio or modem that sends and receives data for monitoring the vehicle ignition state and speed based on the vehicle's location.

9. A modified rear-view mirror as in claim 8 that allows the vehicle to be disabled when the ignition is OFF and vehicle is stopped

10. A rear-view assembly as in claim 9 where the position of the vehicle is determined by the global positioning system.

11. A rear-view assembly as in claim 9 that has inputs and outputs that reads analog data from the vehicle.

12. A rear-view assembly as in claim 9 wherein said processor is externally triggered to disable the ignition of said vehicle.

13. A rear-view assembly as in claim 9 wherein said processor externally trigger to disable the fuel system of said vehicle.

14. Vehicle rear-view mirror assembly electronic device for sending or receiving data, the device immobilizing the vehicle when it is not operating.

15. The vehicle rear-view assembly as in claim 14 wherein said electronic device includes a GPS, the GPS generating a signal that represents the vehicle position.

16. The vehicle rear-view assembly of claim 14 wherein said electronic device includes a processor that is externally triggered to disable the ignition of said vehicle.

17. The vehicle rear-view assembly of claim 14 wherein said vehicle is disabled at a predetermined time and day.
